(19) United States
(12) Patent Application Publication
(10) Pub. No.: US 2002/0191973 A1
(43) Pub. Date: Dec. 19, 2002

(54) Method and apparatus for focus error reduction in a camera

(76) Inventors: Gregory V. Hofer, Loveland, CO (US); Jason E. Yost, Windsor, CO (US); Richard L. Baer, Los Altos, CA (US)

Correspondence Address: HEWLETT-PACKARD COMPANY, Intellectual Property Administration, P.O. Box 272400, Fort Collins, CO, 80527-2400, US

(21) Appl. No.: 09/880,496

(22) Filed: Jun. 13, 2001

(51) Int. Cl. G03B 13/00

(52) U.S. Cl. 396/80; 396/127

(57) ABSTRACT

A method and device for improving the generation of the focus signal in the auto-focus system of a camera.

### FIELD OF THE INVENTION

The present invention relates generally to cameras and more specifically to a method for the reduction of focus errors in cameras.

### BACKGROUND OF THE INVENTION

Many digital cameras use a section of the photo sensor (typically a CCD) to determine a focus metric or signal. This focus signal is used to position a focus lens to obtain the best focus of an object on the photo sensor. The section or region of the photo sensor used to generate the focus signal is typically smaller than the full size of the photo sensor. The focus section or region can be any shape, but is typically rectangular. Individual elements in the photo sensor (typically called pixels or cells) are either completely inside the focus region or are completely outside the focus region. The pixels that are outside the focus region are not used in generating the focus signal. There are a number of problems due to this sharp boundary between pixels inside the focus region and pixels outside the focus region.

One problem is due to camera shake or movement. When there is a high contrast edge falling at the boundary of the focus region, a small movement of the camera can cause the high contrast edge to move in or out of the focus region. This movement of the high contrast edge in or out of the focus region may cause perturbations in the focus signal and may cause the auto-focus algorithm to incorrectly set the focus for the scene.

A similar error occurs when an object being photographed is moving. The movement of the object may cause a high contrast edge to move in or out of the focus region.

Another problem can occur when the change in the position of the focus lens in the camera changes the magnification of the lens system. This change in magnification may cause a high contrast edge in the image to move in or out of the focus region. This movement of the high contrast edge in or out of the focus region may cause perturbations in the focus signal and may cause the auto-focus algorithm to incorrectly set the focus for the scene.

What is needed is a method and apparatus that improves the generation of the focus signal by minimizing the edge effects of the focus region.

### SUMMARY OF THE INVENTION

A method and device for improving the generation of the focus signal in the auto-focus system of a camera.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a top view of a focus region on a photo sensor.

FIG. 2 is a graph of a rectangular window.

FIG. 3 is a graph of a window with a region of non-uniform weighting according to the present invention.

FIG. 4 is a top view of a focus region on a photo sensor that has non-uniform weighting according to the present invention.

FIG. 5 is a graph of the focus metric signal from a rectangular region and a region with non-uniform weighting.

FIG. 6 is a graph of a window where width of the non-uniform weighting is equal to ½ the focus region.

### DETAILED DESCRIPTION OF THE PREFERRED EMBODIMENT

A method and apparatus that improves the generation of the focus signal by minimizing the edge effects of the focus region can reduce the number of images that are incorrectly focused.

During the time a user is composing a scene, a digital camera repeatedly makes new exposures on the photo sensor (typically a CCD). These exposures can be referred to as frames. Typically these frames are a sub-sample of the full resolution of the photo sensor. However, full resolution frames can be created. Some frames are at full resolution but do not use the full size of the photo sensor they use a sub-region of the photo sensor. Frames are used for a number of calculations to help the digital camera determine the proper settings for the capture of the scene. Some examples of the settings are focus, shutter speed, aperture stop, and ISO setting. The shutter speed, aperture stop, and ISO settings are typically tied together to give the proper exposure for the photo sensor.

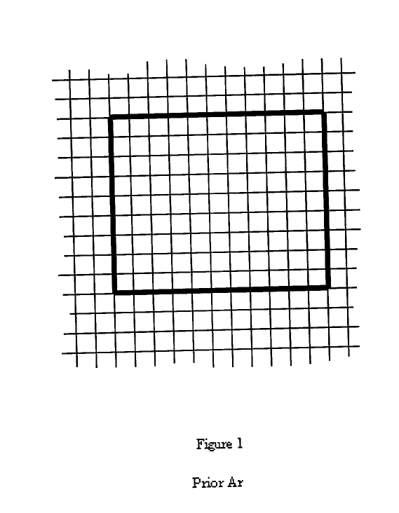

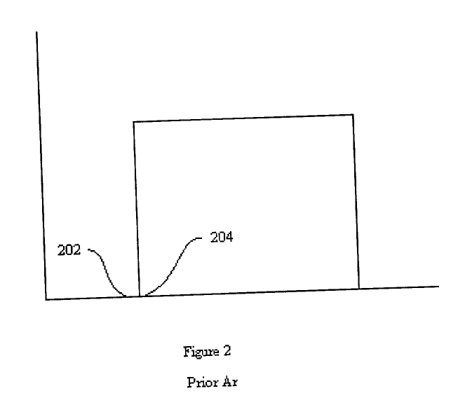

Cameras today typically use a sub-region of the photo sensor when generating frames used to calculate the focus signal. Typically these sub-regions are rectangular in shape, however other shapes can be used. FIG. 1 shows a small area of a typical CCD and the shape of a focus area sub-region. The number of pixels shown inside the focus region has been reduced for clarity and does not reflect the actual number of pixels inside a typical focus region. The focus signal or metric is typically determined by comparing differences or contrast between adjacent pixels within the focus area sub-region. The full signal from each pixel inside the sub-region is used to calculate the focus signal or metric. Pixels outside the focus sub-region are not used in the calculation of the focus signal or metric. The characteristic of focus sensitivity as a function of position on the photo sensor is referred to as a window. When the focus region sensitivity has a hard edge boundary the window is in the shape of a rectangle. FIG. 2 shows a graph of a rectangular window. At pixel 204 the focus sub-region starts and the full signal from pixel 204 is used in the calculation of the focus metric. None of the signal from pixels outside the window are used to calculate the focus signal or metric, for example pixel 202.

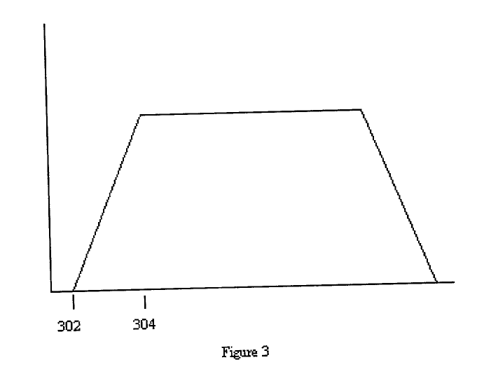

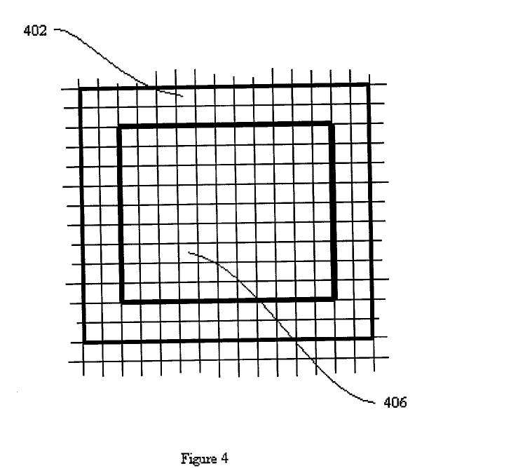

In one embodiment of the current invention the window shape is modified such that the signal from pixels near the edge of the focus sub-region are weighted less than the signal from pixels nearer the center of the sub-region. The weighting function is set such that the change of focus metric caused by scene movement within the weighted region is lower in magnitude than the same scene movement across the boundary of a rectangle window. One weighting method changes the sensitivity from zero at the border of the focus sub-region to full sensitivity at some point inside the focus sub-region, in a linear fashion (See FIG. 3). This technique of windowing is well known in the field of digital signal processing of Fast Fourier Transforms (FFT's). A sample of other windowing shapes that could be used are; Hamming, Hanning, triangular, Kaiser, Chebyshev and Bartlett windows. The region where the signal strength is weighted less than full sensitivity is called the boundary region. The boundary region is shown in FIG. 3 between pixel 302 and pixel 304. This boundary region fully surrounds the focus sub-region on the photo sensor. FIG. 4 is a top view of an area of a photo sensor that contains a focus sub-region. The boundary area is shown by area 402 and the fully weighted focus sub-region is shown by area 406.

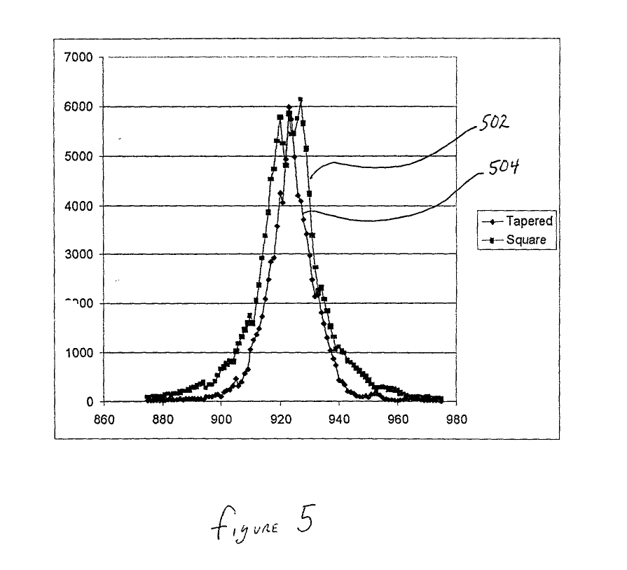

FIG. 5 is a plot of the focus metric signal for a camera that has been moved with respect to an image. The y-axis is the focus metric amplitude and the x-axis is the position of the focus lens as it is scanned through a range of focus positions. Line 502 is for a rectangular window and line 504 is for a window with tapered boundaries as shown in FIG. 3. The auto focus algorithm picks the best focus by finding the maximum amplitude of the focus signal. Line 502 for the rectangular window has significant perturbations due to the camera movement. Line 502 has three strong peaks. The auto focus algorithm may pick one of the incorrect peaks resulting in an out of focus image. Line 504 from the window with the tapered boundary only has one strong peak. The auto focus algorithm would more easily find the correct focus using line 504.

The width of the boundary region may depend on the amount of camera motion projected onto the photo sensor. A given amount of camera movement may result in different amounts of image movement on the photo sensor dependent on the zoom setting of the camera lens. When the lens is at its wide-angle setting a given amount of camera movement may result in only a small movement of the image on the photo sensor. When the lens is at its maximum zoom a given amount of camera movement may result in a large movement of the image on the photo sensor. Changing the width of the boundary in the focus sub-region can minimize the effect of the zoom setting on the focus signal. At maximum zoom the boundary region would be widest and at the wide angle setting the boundary width would be smallest.

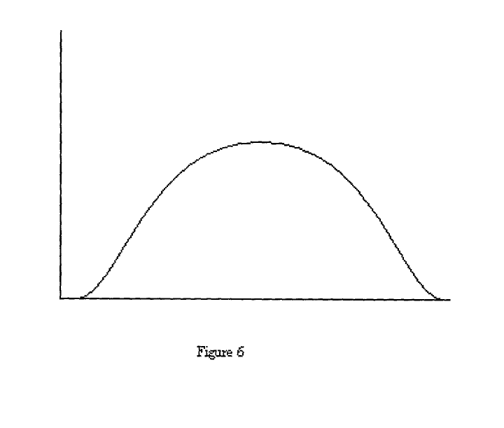

In another embodiment of the current invention the boundary width of the focus sub-region would be ½ the width of the focus sub-region (see FIG. 6). This would result in a focus sub-region where each pixel in a cross section of the focus sub-region may have a different weight in the calculation of the focus signal metric.

The foregoing description of the present invention has been presented for purposes of illustration and description. It is not intended to be exhaustive or to limit the invention to the precise form disclosed, and other modifications and variations may be possible in light of the above teachings. For example, this method can be used in a traditional film camera by having an auxiliary focus system or by having a beam splitter in the main optical path sending light onto a photo sensor. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of adjusting the focus of a camera, comprising:
generating a focus signal using a window with non-uniform weighting;
adjusting the focus using the generated focus signal.

2. The method of claim 1 where the non-uniform weighted area forms a boundary area around the perimeter of the focus signal window; and
the boundary area is less than ½ the width of the focus signal window.

3. The method of claim 2 where the width of the non-uniform weighted area is dependent on the zoom setting of the lens of the camera.

4. The method of claim 3 where the width of the non-uniform boundary area is larger when the zoom setting of the camera is at maximum zoom and the width of the non-uniform boundary area is smaller when the zoom setting of the camera is at a wide angle.

5. The method of claim 1 where the ratio of the width of the focus region with the width of the boundary area is less than 1.

6. The method of claim 1 where the shape of the weighted edge forms a Chebyshev window.

7. The method of claim 1 where the shape of the weighted edge forms a Hanning window.

8. The method of claim 1 where the shape of the weighted edge forms a Hamming window.

9. The method of claim 1 where the shape of the weighted edge is linear.

10. A camera, comprising:
a photo sensor;
a lens system that forms an image on the photo sensor;
a processor configured to calculate a focus metric using a region of the photo sensor,
the processor configured to use a non-uniform weighting for the focus metric region of the photo sensor;
a lens that is focused based on the focus metric.

11. The device of claim 10 where the lens system includes a zoom function; and
the processor is configured to vary the width of the non-uniform weighted region as a function of the zoom position.

12. The device of claim 10 where the lens system is motorized.

13. The device of claim 10 where the camera is a digital camera.

14. A camera, comprising:
a photo sensor;
a lens system that forms an image on the photo sensor;
a means for calculating a focus metric using a non-uniform weighting,
a means for adjusting the focus of the lens using the focus metric.
